(19) United States
(12) Patent Application Publication
(10) Pub. No.: US 2006/0140146 A1
(43) Pub. Date: Jun. 29, 2006

(54) Method for controlling data circuits

(76) Inventors: Johannes Funk, Munster (DE); Ludger Marwitz, Bolcholt (DE)

Correspondence Address: BELL, BOYD & LLOYD, LLC, P. O. BOX 1135, CHICAGO, IL, 60690-1135, US

(21) Appl. No.: 10/563,197

(22) PCT Filed: May 27, 2004
(86) PCT No.: PCT/EP04/50939

§ 371 Date: Jan. 3, 2006

(30) Foreign Application Priority Data
Jul. 3, 2003 (DE) 103 30 077.5
Nov. 21, 2003 (DE) 103 54 472.0

(51) Int. Cl. H04Q 7/00; H04J 3/16

(52) U.S. Cl. 370/329; 370/466

(57) ABSTRACT

A method for controlling data circuits in order to transmit data via data circuits that are allocated to different applications in a local area network. The network includes at least two stations which are configured for transmitting data. At least one first transmission protocol is assigned to a data packet so as to transmit data that is segmented into data packets. The transmission times of the data packets are established in accordance with the assigned transmission protocols if at least one alternative second transmission protocol is provided.

### FIELD OF TECHNOLOGY

The invention generally relates to a method for controlling data circuits in order to transmit data to different applications in a local area network.

### BACKGROUND

As a result of the continued convergence of communication and information technology, networks, such as a local area networks LAN, typically have a plurality of stations configured for transmitting data, with transmission of the data being wire-bound, i.e. over the lines linking the stations. In a local area network (e.g., wireless local area network (WLAN)) that is configured in conformance with the IEEE 820.11 standard transmission is implemented wirelessly, i.e. via a radio link, a hybrid network of stations to be connected via line or radio link.

The stations connected to these networks typically have applications that cover different services. Depending on the type of station applications, may differ from station to station, and are, in some cases, permanently installed. Consequently, the convergence of information and communication technology networks has led to the development of networks and services ranging from the transmission of “non-time-critical” data, as in the case of a file transfer or the transmission of e-mails, to networks with “time-critical” data, such as for example the transmission of voice data (Voice over IP, VoIP), video conferences and streaming media. Time critical data is time-critical, among other reasons, because delays and/or data losses are easily detected by a user and primarily for this reason, real-time transmission of the relevant data is required where possible.

In general, both time-critical and non-time-critical data are transmitted in a WLAN. In an exemplary WLAN arrangement, as shown in FIG. 1, a first station SERV1 and a second station SERV2 are configured as a PC, workstation or server. A third station PP is configured as a mobile terminal device for voice communication, and a fourth station VS1 and fifth station VS2 are configured for displaying video data, which are interconnected via radio by a station providing a radio service area (wireless access point (WAP)) to form a network. The data outputs TCP1, TCP2, UDP_VIDEO1, UDP_VIDEO2, UDP_VOICE1 and UDP_VOICE2 shown in FIGS. 4a and 4b can be observed, for example, in a simulated application of the currently valid IEEE 802.11 standard.

The result of the simulation in conformance with the valid IEEE 802.11 standard in FIG. 4 shows that a bandwidth available for the transmission of data decreases with the number of active services—and consequently of further transmissions—so that as a result a constant data rate required for the (real)time-critical application Video Stream is not guaranteed. As such, data packets are often lost. By contrast, for individual non-time-critical file transfers FTP1 . . . FTP2, a rate of as high as 14 Mb/s is possible.

For this reason, a “quality of service” has been introduced in the IEEE standard 802.11e. Quality of service is deemed to refer to all methods which influence the flow of data in LANs and WANs such that the service reaches the recipient to a defined quality standard. To implement this, a number of approaches have been developed, such as the prioritization of data traffic. The prioritization approach provides that a higher prioritization is assigned to time-critical services, such as video stream, than to non-time critical services. In accordance with the prioritization, data packets which belong to services having a lower priority are always transmitted with a delay, the delay time being determined by the prioritization, so that a higher data rate is achieved for data packets which belong to services having higher priority.

From U.S. Pat. No. 6,452,915, an IP stream classification system for use in a wireless communication system is known, and is incorporated by reference in its entirety herein.

### SUMMARY

Accordingly, a method is disclosed which reduces the loss of real-time-critical transmission packets relative to non-real-time-critical transmission packets within a station of a radio telecommunication system.

In one exemplary embodiment, data is transmitted via data circuits that are allocated to different applications in a local area network having at least two stations. At least one first transmission protocol or at least one alternative second transmission protocol is assigned to a data packet so as to transmit data that is segmented into data packets. A first transmission protocol preferably functions in conformance with a connection-oriented transport protocol and the second transmission protocol preferably functions in conformance with a connectionless transport protocol. The data packets of the first transmission protocol are preferably managed by the station in one queue and the data packets of the second transmission protocol are managed in another queue. The transmission times of the data packets are established in accordance with the assigned transmission protocol, wherein the establishment of the transmission times are carried out on the basis of a first prioritization such that different priorities are assigned to the transmission protocols.

Under the exemplary embodiment, a local area network is able to respond more flexibly to the availability of a selection of multiple transmission protocols. This degree of freedom also makes it possible to balance out the advantages and disadvantages of the transmission protocols so that the effectiveness and utilization of the resource capacity of the local area network can be increased.

Furthermore, the transmission times are established on the basis of a first prioritization such that different priorities are assigned to the transmission protocols in a manner where protocols can be weighted according to at least one of their characteristics and so that control algorithms are in a position to incorporate these characteristics within the network at advantageous times.

Additionally, the transmission times can be set on the basis of a second prioritization in a manner where the data packets are prioritized according to their assignment to applications. This enables the observance of different service quality requirements demanded of applications to which the same transmission protocol is assigned. In addition, a further layer for adjusting network characteristics, which allows more adapted data flow control, is achieved.

Moreover, a first transmission protocol may function in conformance with a connection-oriented transport protocol, in particular the TCP protocol, and a second transmission protocol, functions in conformance with a connectionless transport protocol, in particular the UDP protocol, a lower priority preferably being assignable to the first transmission protocol than to the second protocol. This prevents packets of the connectionless protocol being lost as a result of algorithms assigned to the connection-oriented transmission protocol increasing the data throughput on a transmission medium up to saturation level. Such losses would be noticeable mainly in the case of connectionless transmission protocols since, as their loss cannot be detected, no repetition of the packet occurs. By contrast, losses of packets sent using a connection-oriented transmission method can be detected and consequently resent. Since connectionless transmission protocols are often used for data transmission by video and voice applications, this would result in an increasing number of disruptive situations. Using the disclosed method, by contrast, the packets of the connection-oriented transmission protocol are managed in a different queue of the station concerned from that used for the packets of the connectionless transmission protocol, so that the algorithms of the connection-oriented transmission protocols can continue to operate advantageously, but not at the expense of data transmission in conformance with connectionless transmission protocols.

The local area network preferably functions as a LAN, in particular as a wireless local area network (WLAN) in conformance with the IEEE 802.11 standard and its derivatives, so that text, video and voice transmission applications can be used.

Central establishment of transmission times has the advantage that the method has to be implemented only on one or a small number of local area network instances, while local control has the advantage that stations implementing the method can be incorporated within networks at no great cost and/or without changes to existing networks.

Here, the establishment of transmission times preferably takes place, particularly in the case of local control, on the basis of information in an IP priority field, so that information about the transmission protocol used can be evaluated locally in the stations.

### BRIEF DESCRIPTION OF THE DRAWINGS

The various objects, advantages and novel features of the present disclosure will be more readily apprehended from the following Detailed Description when read in conjunction with the enclosed drawings, in which:

FIG. 1 illustrates a WLAN arrangement according to the prior art;

FIG. 2 illustrates behavior of an exemplary TCP algorithm;

FIG. 3 illustrates a schematic representation of a procedure according to an exemplary embodiment;

FIGS. 4a and 4b show simulation results using the arrangement shown in FIG. 1 (IEEE 802.11); and

FIGS. 5a and 5b show simulation results using the arrangement shown in FIG. 1 under the exemplary embodiment.

### DETAILED DESCRIPTION

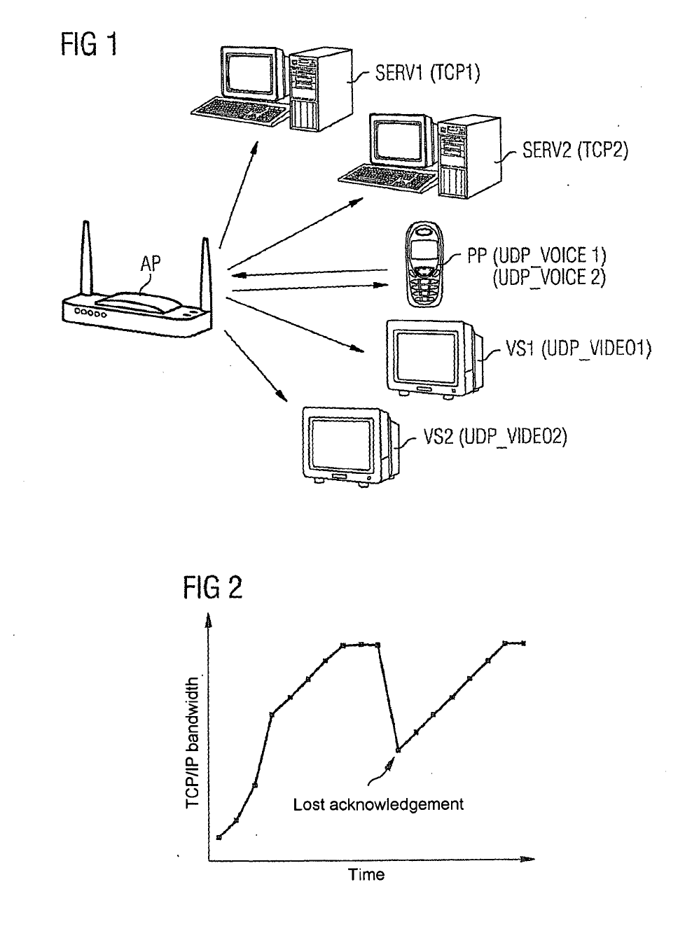

FIG. 2 shows a data throughput as produced in conformance with a TCP/IP algorithm. It is evident from this that the algorithm increases the throughput until no further increase is possible.

This saturation makes itself noticeable in that data packets are lost, i.e. no acknowledgement signal (ACK) comes back.

When this is detected, the throughput is decreased somewhat. As soon as ACK signals are no longer being lost, the data rate is increased again until such time as data packets are again being lost. In this way, a dynamic balance with other data flows is arrived at, resulting in a maximum data rate.

However, this algorithm also causes other data flows to lose packets. If these other data flows are likewise using the TCP/IP transmission protocol, this effect does not result in any permanent loss of packets as these unacknowledged packets are recognized as lost and sent once again.

If, however, the competing data flow is, for example, a UDP stream, as is preferably the case for voice and video data, then this has fatal consequences. The data packets are permanently lost and result in poor transmission characteristics. A high quality of service QoS can no longer be guaranteed.

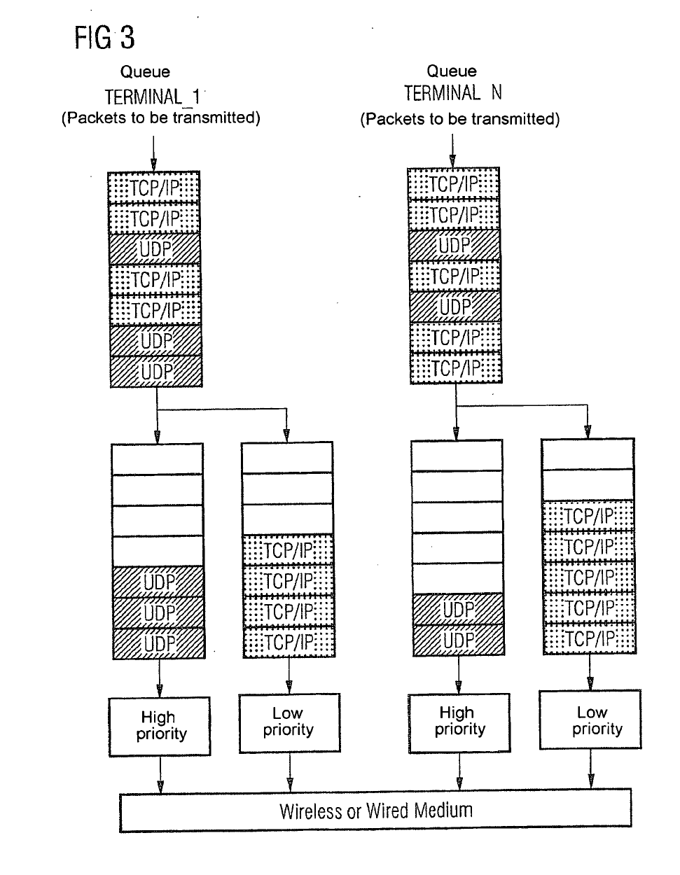

In an exemplary embodiment illustrated schematically in FIG. 3, it is therefore provided that, for a system which also transmits data flows in conformance with a protocol such as a UDP protocol, the protocol does not contain any dynamic increase of the throughput up to the limit. To this end, a solution to the problems discussed above is achieved using a prioritization of the protocol.

As can be seen from the exemplary diagram, UDP data packets which are to be transmitted in conformance with the UDP protocol are given higher priority in the queue of data packets for transmission, while TCP/IP data packets which function in conformance with the TCP/IP protocol are given a lower priority by comparison.

The data packets divided up in this manner in the queues of the individual stations TERMINAL_1 . . . TERMINAL_N then go, guided by further access control methods, to the transmission medium WIRELESS OR WIRED MEDIUM.

The outcome of this is that the UDP data flows (streams) are no longer disturbed by TCP/IP data flows, while the TCP/IP streams continue to behave toward one another as previously.

The result is, for example, an undisturbed telephone call via WLAN or undisturbed video enjoyment while it is simultaneously possible to surf the Internet from the same or a different terminal.

In order to achieve high-quality transmissions, it also is preferable to prioritize the data packets which are sent by means of the UDP protocol only in the event of a conflict arising.

Accordingly, it will no longer be necessary to differentiate according to applications. Alternatively or additionally, it will be possible for the priority decision to be taken locally on the basis of information about the protocol in the IP priority field.

A further advantage of the described method is, moreover, that only two different queues will be necessary for data processing (TCP/IP and UDP) and not four as recommended by the current Draft Standard IEEE 802.11 E. This will lead to a reduction of complexity in the terminal and consequently to a cost advantage.

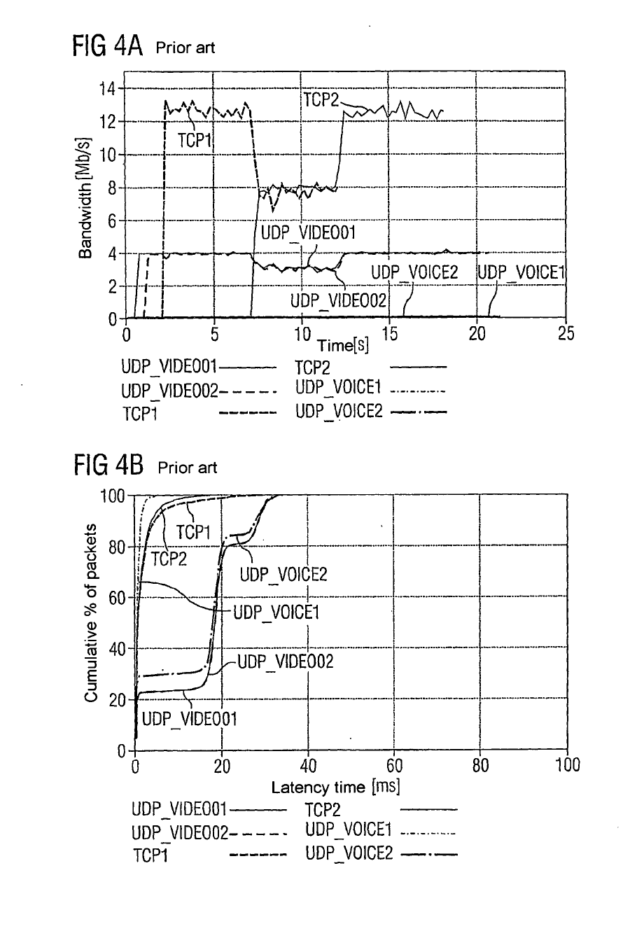

This will become clear if, with reference to FIGS. 4 and 4b, one first looks at results of the simulation of a current WLAN network.

UDP streams which are labeled UDP_VIDEO1 and UDP_VIDEO2 can be seen; these are shown to be adversely affected by the competing dynamic balance of TCP/IP streams, for example that with TCP1 and TCP2, so that UDP data packets are lost. This leads to poor characteristics in terms of quality of service for services using UDP. The deleted TCP/IP packets, on the other hand, are recognized by the protocol and resent.

It is clear from the representation in FIG. 4b that, even with the delay times, the quality of the UDP streams diminishes, since values up to approx. 35 ms occur in the WLAN network on which the simulation is based and which is known in the prior art.

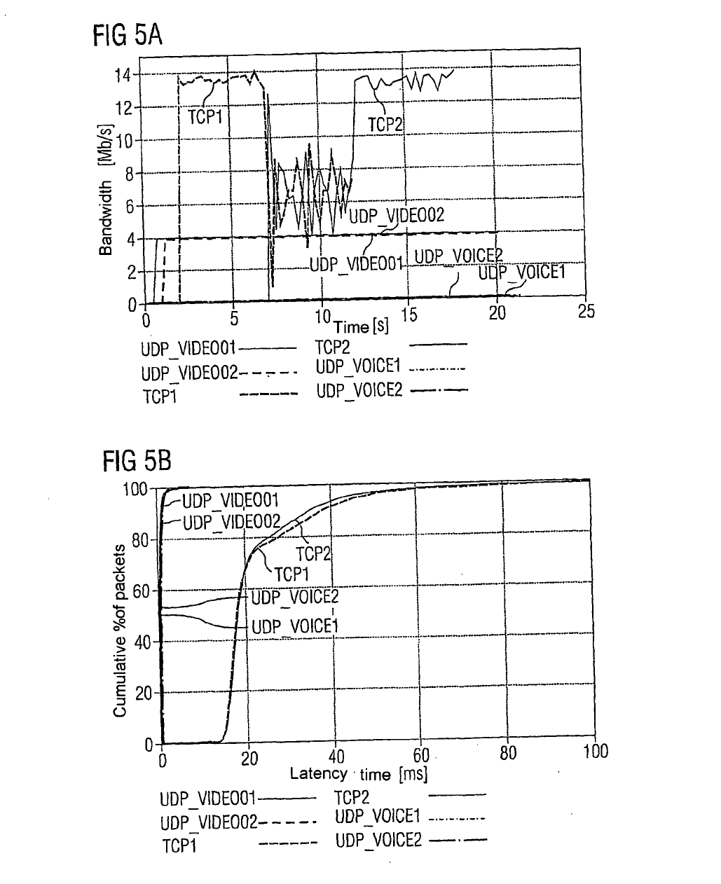

In contrast, it can be seen from the result of a simulation of a WLAN network using the disclosure herein, which is represented in FIG. 5a and shows the throughput, that after prioritization of the UDP streams no further data packets are lost. The dynamic balance brought about by the TCP/IP algorithm continues to function only between the TCP/IP streams. As a result, the quality of service for the applications such as voice and video using the UDP protocol is excellent.

The representation of the delay times (latency times) produced as a result of the simulation in FIG. 5b supports this conclusion as it can be seen that even the delay times assume excellent values for the UDP streams. This stems from the fact that the values lie far below approx. 10 ms despite intense TCP/IP traffic in the WLAN network using the disclosed method.

It should be understood that the various changes and modifications to the presently preferred embodiments described herein will be apparent to those skilled in the art. Such changes and modifications can be made without departing from the spirit and scope of the present disclosure and without diminishing its intended advantages. It is therefore intended that such changes and modifications be covered by the appended claims.

1-9. (canceled)

10. A method for controlling data transmitted via data circuits allocated to different applications in a local area network, said method comprising the steps of:
receiving data in the form of data packets, wherein the packets are assigned to at least one of a connection-oriented transport protocol and a wireless transport protocol;
managing the data packets of the connection-oriented transport protocol in a first queue and the data packets of the wireless transport protocol in a second queue; and
establishing transmission times of the data packets in accordance with the assigned transmission protocol on the basis of a first prioritization wherein different priorities are assigned to the transmission protocols in the respective queue.

11. The method according to claim 10, wherein the transmission times are established on the basis of a second prioritization such that the data packets are prioritized according to their assignment to applications.

12. The method according to claim 10, wherein, the connection-oriented transport protocol performs a TCP function and the connectionless transport protocol performs a UDP function.

13. The method according to claim 12, wherein a lower priority is assigned to the first transmission protocol as compared to the second protocol.

14. The method according to claim 10, wherein the local area network functions as a wireless local area network (WLAN) in conformance with the IEEE 802.11 standard.

15. The method according to claim 14, wherein the establishment of transmission times is controlled by at least one wireless access point (WAP) of the local area network.

16. The method according to claim 14, wherein the establishment of transmission times is controlled locally by stations of the local area network.

17. The method according to claim 10, wherein the establishment of transmission times is carried out on the basis of information in an IP priority field.
